(19) United States
(12) Patent Application Publication
(10) Pub. No.: US 2005/0241231 A1
(43) Pub. Date: Nov. 3, 2005

(54) Methods and devices for promoting the growth of plant air roots

(75) Inventors: W. Michael Bissonnette, Boulder, CO (US); Robert E. Wainwright, Longmont, CO (US); John Thompson, Boulder, CO (US)

Correspondence Address: AeroGrow International, Inc., Suite 201, 900 28th St., Boulder, CO, 80303, US

(73) Assignee: AeroGrow International, Inc., Boulder, CO (US)

(21) Appl. No.: 11/079,054

(22) Filed: Mar. 14, 2005

Related U.S. Application Data
(60) Provisional application No. 60/552,599, filed on Mar. 12, 2004.

(51) Int. Cl. A01G 9/02

(52) U.S. Cl. 47/81

(57) ABSTRACT

This invention provides methods, devices, and kits that are useful for growing plants and germinating seeds and that improve the delivery of oxygen by promoting growth of air roots. The devices of this invention include a vessel for containing a liquid, a suspending means for suspending a plant or seed in a gas above the liquid; a liquid delivering wicking filter supported by a filter supporting means. The filter has one or more holes. At least a portion of the filter is at about or above the surface of said liquid and the filter contacts the liquid and delivers the liquid to the seed or plant. The filter decreases the likelihood that a first root of the plant grows through the filter and into the liquid or increases the mass of a root that grows in the gas, each relative to an equivalent context without a filter. The filter is designed to allow none or some of the roots to grow into the liquid, water roots, while directing some roots to grow in the air, air roots, above the filter.

This application claims priority under 35 U.S.C. 119(e) to provisional patent application 60/552,599, filed Mar. 12, 2004, which is hereby incorporated by reference in its entirety to the extent not inconsistent with the disclosure herein.

### FIELD OF THE INVENTION

This invention is in the fields of plant agriculture, home gardening, hydroponics, and wicking systems.

### BACKGROUND

Hydroponics is the cultivation of plants without soil. In soil-less culture, plants are cultivated using a liquid solution of water and nutrients. There are 6 basic types of hydroponic systems: Wick, Raft (also called Water Culture), Ebb and Flow (also called Flood & Drain), Drip, Nutrient Film Technique, and Aeroponic systems. There are hundreds of variations on these basic types of systems, and most hydroponics systems can be described as a variation or combination of these six types.

Wicking hydroponic systems can be simple, passive systems, with no moving parts. Plants are grown in a soil-less growing medium and a liquid containing water and nutrients is delivered using wicks that absorb the solution from a reservoir and deliver the liquid to the growing medium. In non-circulating wicking systems, liquid in the reservoir often contains low levels of oxygen, limiting plant growth. Therefore many wicking systems are designed to allow roots to grow directly in air and encourage the growth of air roots for obtaining oxygen.

Raft systems can also be very simple. Plants are grown in a soil-less growth medium that is floated by a raft on the surface of a liquid containing water and nutrients.

Ebb and Flow systems are more complex. The plants are grown in a soil-less growth medium in a flooding tray. Liquid containing water and nutrients is intermittently delivered to the flooding tray and then returned to a reservoir. The plant roots are directly or indirectly contacted by the liquid in the flooding tray. Optionally the solution is delivered by a pump and returned by gravity. The flooding cycle is optionally controlled by a timer.

Drip systems are divided into recovery and non-recovery systems. Plants are grown in a soil-less growing medium. A solution containing water and nutrients is delivered in drips to the growing medium. The solution that is not used by the plants is either recycled (recovery systems) or discarded (non-recovery systems). In recovery systems, although there often is a reservoir, the plant roots are typically prevented from growing directly in the solution.

Nutrient Film Technique (N.F.T.) systems constantly deliver a thin film of a nutrient and water containing liquid. The plants are grown in a soil-less growth medium and the roots are allowed to grow outside the medium into the surrounding air or the plants are grown directly suspended in the air without a growing medium. The portions of the roots that grow in the air are constantly contacted by the thin film of liquid. Typically the solution is recycled. Optionally the liquid is delivered by a pump and returned by gravity.

Aeroponic systems deliver the solution as a fine spray. The plants are grown in a soil-less growth medium and the roots are allowed to grow outside the medium into the surrounding air or the plants are grown directly suspended in the air without a growing medium. The roots that grow in the air are intermittently sprayed or misted with a liquid containing water and nutrients. The roots of the plants are optionally prevented from or allowed to grow in the solution. Typically a timer is used to regulate the spraying cycle.

In many hydroponic systems, including wicking, raft, ebb and flow, and NFT systems, plant growth is limited by the amount of oxygen in the liquid, which, unless supplemented, is often low. A variety of techniques and methods have been utilized to increase the amount of oxygen delivered to plants in hydroponic systems.

Plant roots differentiate to fulfill specialized functions. For example, roots that grow in liquid specialize at obtaining components from liquid and roots that grow in gas specialize in obtaining components from gas. Hydroponic systems can be designed to encourage roots to grow in air and therefore specialize in obtaining oxygen from the air, thereby eliminating the problems with using low oxygen containing liquids.

Allowing roots to grow in air, in both hydroponic systems and soil growing systems, can be risky because if the roots in the air become submerged in liquid, they roots can suffocate and the plant can wilt and die. A variety of techniques and methods have been utilized to decrease the likelihood that roots grown in air can become submerged in liquid.

A variety of screening methods have been used to divide roots into different growing zones, to allow for specialization and/or to prevent suffocation.

Kratky, B. A. (U.S. Pat. No. 5,385,589, issued Jan. 31, 1995; U.S. Pat. No. 5,533,299, issued Jul. 9, 1996; and HortTechnology, April/June 1993, pp 206-7) describes non-circulating hydroponic plant growing systems having plastic container tubes with apertures out of which the roots are permitted to grow. Seeds can be planted in a growing medium in the tube and watered from the top or the tubes can be placed in a nutrient solution and solution enters through the apertures and wets the growing medium inside.

U.S. Pat. No. 4.106,235, issued Aug. 15, 1978, describes a flower pot with a window screen at the bottom that supports the growing medium within and allows roots to grow through into a liquid below.

WO 03/011010, published 13 Feb. 2003, describes an apparatus for hydroponic cultivation with a root retaining mechanism for preventing primary roots from traveling from a growing chamber with holes into a nutrient solution reservoir by utilization of a root prune window. A combination of growing media is required to allow some roots to grow as water roots and others to grow as air roots. Nutrient solution is pumped from the reservoir up into the growing medium and delivered by drip irrigation. The solution is delivered by a variety of means, including by rain-like droplets or mist from above the roots.

Higaki, T. et al., 1992, University of Hawaii Horticulture Digest, 97:1-4 describe an Anthurium aeroponics system in which saran cloth was placed below mature plants for the roots to cling and to provide structural support.

None of the above-described references utilizes a material with holes to increase the mass of roots growing in a gas and decrease the mass of roots growing in a liquid relative to an equivalent context without the material with holes.

WO 94/13129, published 23 Jun. 1994, describes a plant growing apparatus and process wherein the plant grows in three zones for different parts of the plant, allowing for delivery of plant husbandry fluids to selected zones.

Kratky, B. A. et al. (Proc. 21^{st} Nat. Agr. Plastics Congress, 1989, pp 22-27 and HortScience, October 1988, 23(5):906-907) describe a non-circulating hydroponic system with a net or layer of window screen. The nutrient level is initially above the net and in contact with transplanted seedling roots and then the nutrient level is decreased and maintained 10 to 20 mm below the net.

Http://www.fabricworkshop.com/af0102.htm describes a method for using non-metallic door or window screen draped in a hydroponic garden, optionally into the nutrient solution, to provide resistance and force a plant to send out side roots, eventually growing roots through the screen.

Http://www.hydrofarm.com/content/articles/avrdc.html and Imai, H. 1987, AVRDC non-circulating hydroponics system, pp 109-122 (C. C. Tu and T. F. Sheen eds.) describe a hydroponics system with a net for separating roots responsible for oxygen uptake from roots responsible for nutrient absorption. Two systems are described, one in which the nutrient level is initially above the net and in contact with transplanted seedling roots and then allowed to recede and maintained at about 1-2 cm below the net, and the second in which the net floats on the surface of the nutrient.

U.S. Pat. No. 6,088,958, issued Jul. 18, 2000, describes a process for producing potato tubers using a partition member of a 0.5 to 5 cm above the nutrient solution through which roots of potatoes can pass while stolons of potatoes cannot pass. Liquid is preferably delivered by NFT methods.

None of the above-described devices and methods provide a stochastic root filter that promotes development of oxygen roots and that also functions as a liquid delivery means for providing liquid to a plant from seed germination through harvest and maturity.

### SUMMARY OF THE INVENTION

This invention provides methods, devices, and kits for growing a plant or germinating a seed into a plant, said plant comprising a plurality of roots, said device comprising: a vessel for containing a liquid, said liquid comprising an uppermost surface; a suspending means for suspending said plant or seed in a gas above said liquid; a liquid delivering wicking filter supported by a filter supporting means, said filter having one or more holes; wherein at least a portion of said filter is at about or above the surface of said liquid; wherein said filter contacts said liquid and delivers said liquid to said seed or plant; wherein said filter decreases the likelihood that a first root of said plurality of roots grows through said filter and into said liquid or wherein said filter increases the mass of the portion of a second root that grows in said gas, each relative to an equivalent context without said filter.

In an embodiment, a first portion of said plurality of roots grows in said gas at about or above said filter and the remaining second portion of said plurality of roots grows through said one or more holes in said filter and into said liquid. In an embodiment, none of said plurality of roots is allowed to grow through said filter and into said liquid below said filter. In an embodiment, all of said filter is moist. In an embodiment, said filter is stochastic or size selective.

This invention provides a method for growing a plant or germinating a seed into a plant, said plant comprising a plurality of roots, said method comprising: providing a vessel for containing a liquid, said liquid comprising an uppermost surface; providing a suspending means and suspending said plant or said seed in a gas above said liquid; providing a liquid delivering wicking filter having one or more holes; wicking said liquid to said plant or seed with said filter; providing a supporting means and supporting at least a portion of said filter at about or above said liquid surface; and filtering at least a portion of said plurality of roots; whereby the likelihood that a first root of said plurality of roots grows through said filter and into said liquid is decreased or wherein the mass of the portion of a second root that grows in said gas is increased, each relative to an equivalent context without said filter and said filtering. In an embodiment, the method includes germinating said plant from seed.

This invention provides filters useful with the methods and devices of this invention.

### BRIEF DESCRIPTION OF THE DRAWINGS

FIG. 1 is an illustration showing a perspective view of a device of this invention having a filter with round uniform holes except for the wick opening, showing the interior.

FIG. 2 is an illustration showing a perspective view of a device of this invention having a filter with rectangular non-uniform holes, showing the interior.

FIG. 3 is an illustration showing a perspective view of a device of this invention having a hydrophilic wicking filter with rhombus holes, showing the interior.

FIG. 4 is an illustration showing a perspective view of a device of this invention having a filter that also functions as the wick, showing the interior.

FIG. 4 is an illustration of a filter of this invention having a changing hole:matrix ratio.

FIG. 5 is an illustration of a filter 6 of this invention in which the size and shape of the holes change as the roots grow.

FIGS. 6A and 6B are side and longitudinal cross-sectional illustrations of a filtering device of this invention having three floating tiers of different sizes.

FIGS. 7A-C are illustrations of a device of this invention showing the positions of the filter tiers with the water at high, medium, and low levels.

FIGS. 8A-B are illustrations of a device of this invention with a mature plant and some roots growing in the interior of the tiered filter and other roots growing in the filter and through the filter into the liquid, at high and low liquid levels, respectively.

### DETAILED DESCRIPTION OF THE INVENTION

As is used in the art and as used herein, a “vessel” is able to contain a composition and optionally has a bottom wall and/or one or more side walls. The bottom wall can have horizontal and vertical components as in a hemisphere.

As used herein, “wicking” refers to absorbing and transfering aqueous liquids. As used herein, “wicking means” refers to a means for wicking a liquid. A wicking means can be a wick comprising a wicking material. As is known in the art, materials differ in the ability to wick, which is described as an absorption coefficient. Different materials are able to wick different quantities of liquids at different rates.

As used herein, “filter” refers to a material or device that can statistically permeable to a fraction of a plurality of items over a time period or selectively permeable based on a characteristic of the items, such as size. As used herein, “statistically permeable” and “stochastically permeable” refer to permeability that is not selective based on a characteristic of the item but random or stochastic. Permeability is a result of the location of the filter that is contacted by an item. When an item, such as a root, contacts the filter, it is at a location that is either at a hole in the filter or the matrix of the filter. The item then either passes through or not depending on at which location it contacts the filter. The permeability of a random or statistical filter is dependent upon the hole:matrix ratio of the filter and the cross-sectional diameter and shape of the holes, as is known in the art. A filter can comprise more than one filtering layer. Filters useful in the practice of this invention are permeable to no roots or at least one root.

As is used in the art and used herein, “float” refers to the ability of a material to remain at about a liquid surface and not sink, as a result of the different effective densities of the material and the liquid.

As used herein, “decreasing the likelihood” that an event will occur refers to the likelihood that the event will occur in one set of conditions relative to another set of conditions. “Decreased the likelihood that a root of a plurality of roots of a plant will grow into a liquid” refers to the decreased likelihood that a root will grow through a filter and into a liquid relative to growing into an equivalent liquid from an equivalent location when no filter or a different filter is present, over a period of time.

As used herein, “hole” refers to an opening completely through a material from one side to the opposite side. As used herein, holes have about the same cross-sectional area and shape through the entire material. As used herein, “shape” refers to the two-dimensional shape of a cross-sectional area, including, but not limited to, square, circle, rectangle, oval, rhombus, parallelogram, polygon, and irregular curved shapes. As used herein, the two dimensions of a rectangle define the percentage of the rectangle, e.g. an 80% rectangle has a shorter side that is 80% the length of the longer side. A 100% rectangle is a square. As used herein, a “greater than 80% rectangle” has a shorter side that is greater than 80% of the length of the longer side.

As used herein, “air roots” are roots of a plant that grow in a gas comprising oxygen and specialize in obtaining oxygen from the gas Although applicants do not wish to be bound by any particular theory, air roots may be similar to aerial roots and may form special channels called lenticels for gas exchange, similar to the pneumathodes of pneumatophores. As used herein, “water roots” are roots that grow in aqueous liquids and specialize in obtaining dissolved oxygen and other nutrients from the aqueous liquid. Air roots are not as good as water roots at obtaining oxygen and nutrients from aqueous liquids and water roots are not as good as air roots at obtaining oxygen from a gas comprising oxygen gas. Although applicants do not wish to be bound by any particular theory, growing in air may induce roots to differentiate into air roots and growing in an aqueous liquid may induce roots to differentiate into water roots.

As used in the art and as used herein, “nutrients” refers to atoms and molecules in an available form necessary for plant growth in addition to oxygen, hydrogen, and water including calcium, magnesium, sodium, potassium, nitrogen, phosphorus, sulfur, chlorine, iron, manganese, copper, zinc, boron, and molybdenum. Nutrient formulations and recipes are known in the art (see, for example, Resh H. M (2001) Hydroponic Food Production, Sixth Addition, Woodbridge Press Publishing Company, Santa Barbara, Calif., USA). It is known in the art that a liquid used to supply nutrients to a plant are optimally within a particular pH range. Optimal pH ranges for a variety of plants are known in the art. As used herein, “photoradiation” refers to wavelengths of light of sufficient quantity and quality that allow a plant to grow, as is known in the art.

The components illustrated in the drawings are numbered as shown in Table 1.

TABLE 1

| Item | Number |
|---|---|
| 1 | plant growing device |
| 2 | plant |
| 3 | cover |
| 4 | opening |
| 5 | wick |
| 6 | filter |
| 7 | air root |
| 8 | rim |
| 9 | water root |
| 10 | gas |
| 11 | liquid |
| 12 | vessel |
| 13 | wick hole |
| 14 | one or more holes |
| 15 | diameter |
| 16 | liquid surface |
| 17 | filter rest |
| 18 | artificial photoradiation source |
| 19 | natural photoradiation source |
| 20 | plant support |
| 21 | matrix |
| 22 | hooks |
| 23 | wicking filter |
| 24 | germination cover |
| 25 | floating means |
| 26 | first filter tier |
| 27 | second filter tier |
| 28 | third filter tier |
| 29 | growing medium |

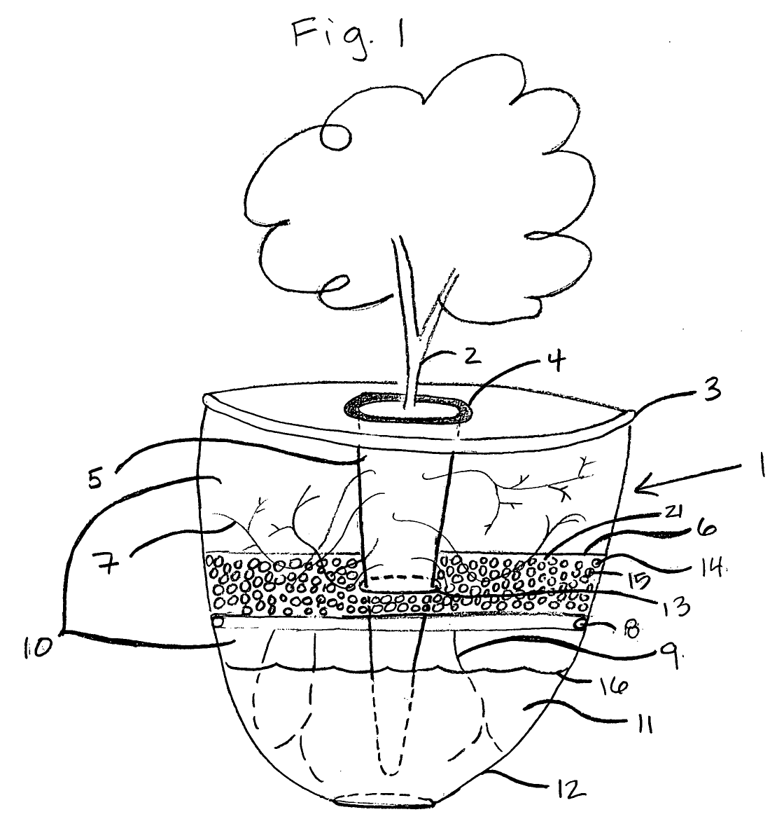

FIG. 1 shows a device 1 of this invention. The round vessel 12 contains a liquid 11. The vessel 12 is enclosed by a removable cover 3 which has an opening 4 in which a plant 2 is suspended by a wick 5 which fits snugly in the opening 4. The wick 5 passes through a wick hole 13 in a filter 6 which rests above the liquid surface 16 on a rim 8 on the inside surface of the side wall of the vessel 12. The wick 5 contacts and is partially immersed in the liquid 11. The filter 6 has a plurality of circular holes 14 which have a diameter 15 of about 6mm. The filter 6 is about 33% holes 14 and about 67% matrix 21. An air root 7 grows above the filter 6 in the gas 10 and a water root 9 grows below the filter and into the liquid 11.

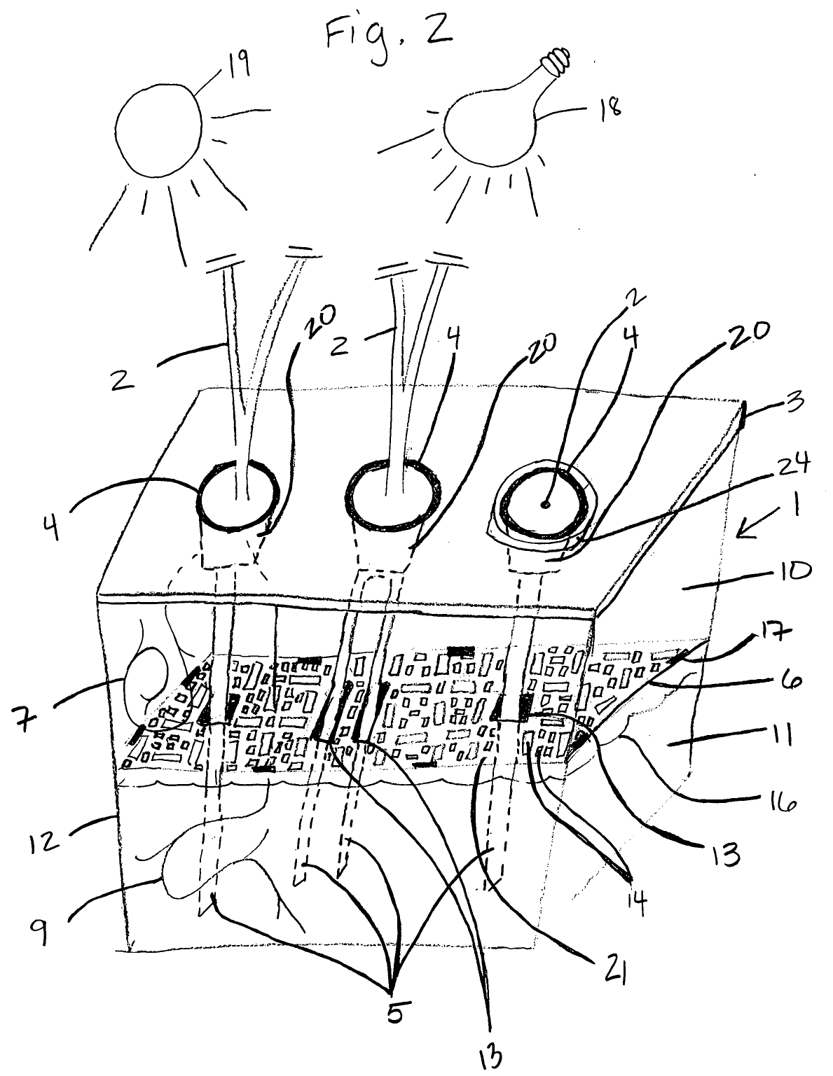

FIG. 2 shows a device 1 of this invention. The rectangular vessel 12 contains a liquid 11. The vessel 12 is enclosed by a removable cover 3 which has three openings 4 in which plants 2 are suspeneded by wicking plant supports 20 which fit snugly in the openings 4 and are attached to wicks 5. The wicks 5 pass through wick holes 13 in a filter 6 which rests above the liquid surface 16 on filter rests 17 on the inside surface of the side walls of the vessel 12. The wicks 5 contact the liquid 11. The filter 6 has a plurality of holes 14 which are rectangles of various cross-sectional areas. The filter 6 is about 40% holes 14 and about 60% matrix 21. An air root 7 grows above the filter 6 in the gas 10 and a water root 9 grows below the filter and into the liquid 11. An optional artificial photoradiation source 18 and an optional natural source 19 are shown. A removable germination cover 24 covers a seed 2 in the right most opening 4.

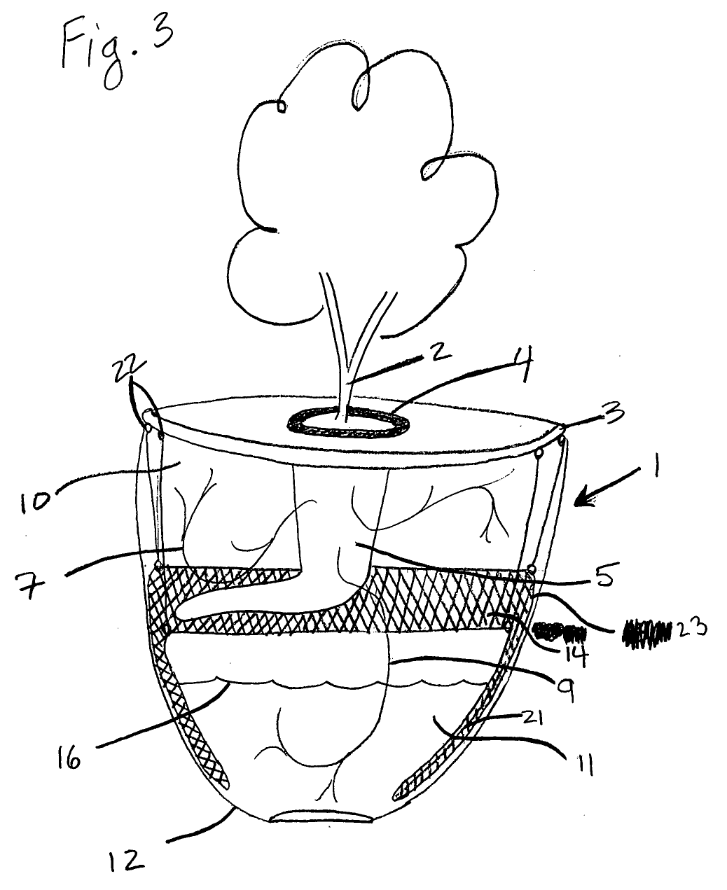

FIG. 3 shows a device 1 of this invention. The round vessel 12 contains a liquid 11. The vessel 12 is enclosed by a removable cover 3 which has an opening 4 in which a plant 2 is suspended by a wick 5 which fits snugly in the opening 4. The wick 5 rests on a filter 6 which is suspended at a level 24 above the liquid surface 16 from hooks 22 on the cover 3 and which wick 5 hangs into the liquid 11. The filter 6 has a plurality of rhombus holes 14 and is about 75% holes 14 and about 25% matrix 21. An air root 7 grows above the filter 6 in the gas 10 and a water root 9 grows below the filter and into the liquid 11.

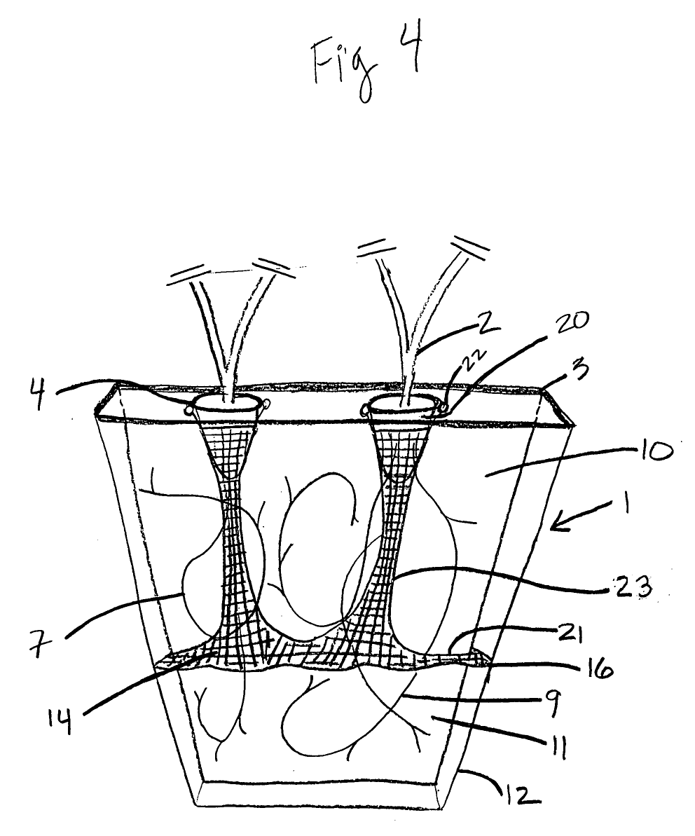

FIG. 4 shows a device 1 of this invention. The square vessel 12 contains a liquid 11. The vessel 12 is enclosed by a removable cover 3 which has two openings 4 in which plants 2 are suspended by wicking plant supports 20 which fit snugly in the openings 4 and are attached to a wicking filter 23, suspended by hooks 22 on the cover 3, that floats at about the liquid surface 16 as the liquid level rises and falls. The wicking filter 23 has a plurality of holes 14 which are squares and is about 85% holes 14 and about 15% matrix 21. An air root 7 grows above the wicking filter 23 in the gas 10 and a water root 9 grows below the filter and into the liquid 11.

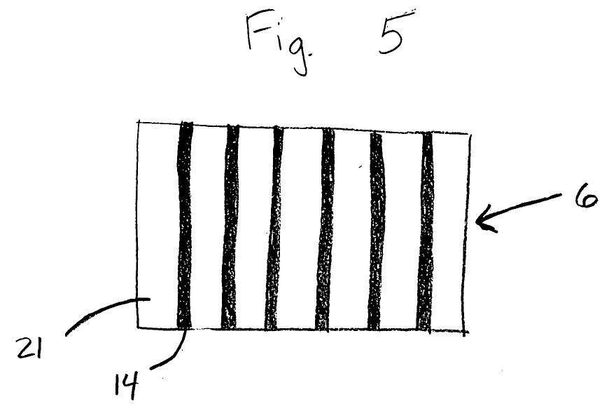

FIG. 5 shows a filter 6 of this invention. The matrix 21 is made of capillary matting. The holes 14 are spaces between the strips of matting. The matrix is hydrophilic, capable of wicking, and flexible, such that the cross-sectional area, shape, and hole 14 to matrix 21 ratio varies as roots (not shown) grow.

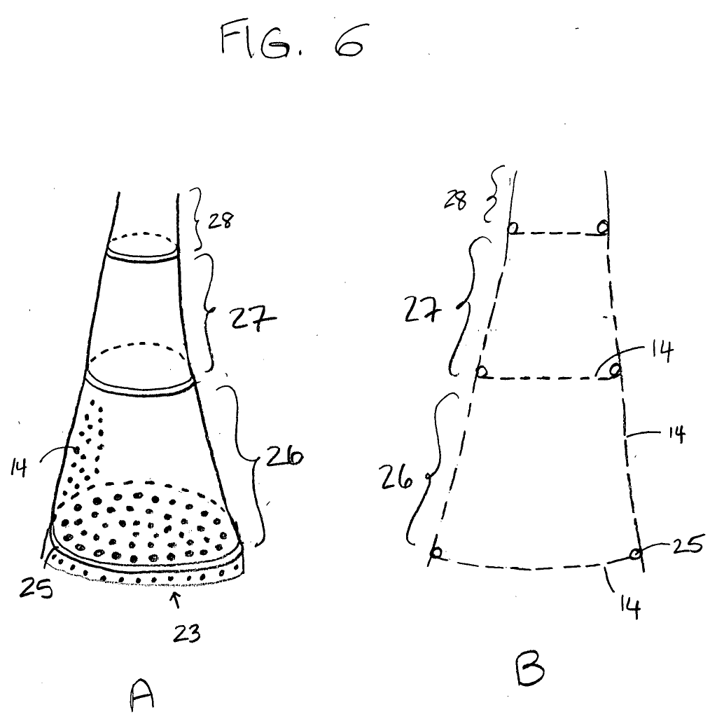

FIGS. 6A and 6B show a filtering device of this invention. FIG. 6A shows the device from the side. The device has three filtering tiers, each tier containing a floating means. The cross-sectional diameter of each tier is smaller than the tier below, with the lowest tier having the largest cross-sectional diameter. FIG. 6B shows a longitudinal cross section of the filter in 6A. The floating means are visible.

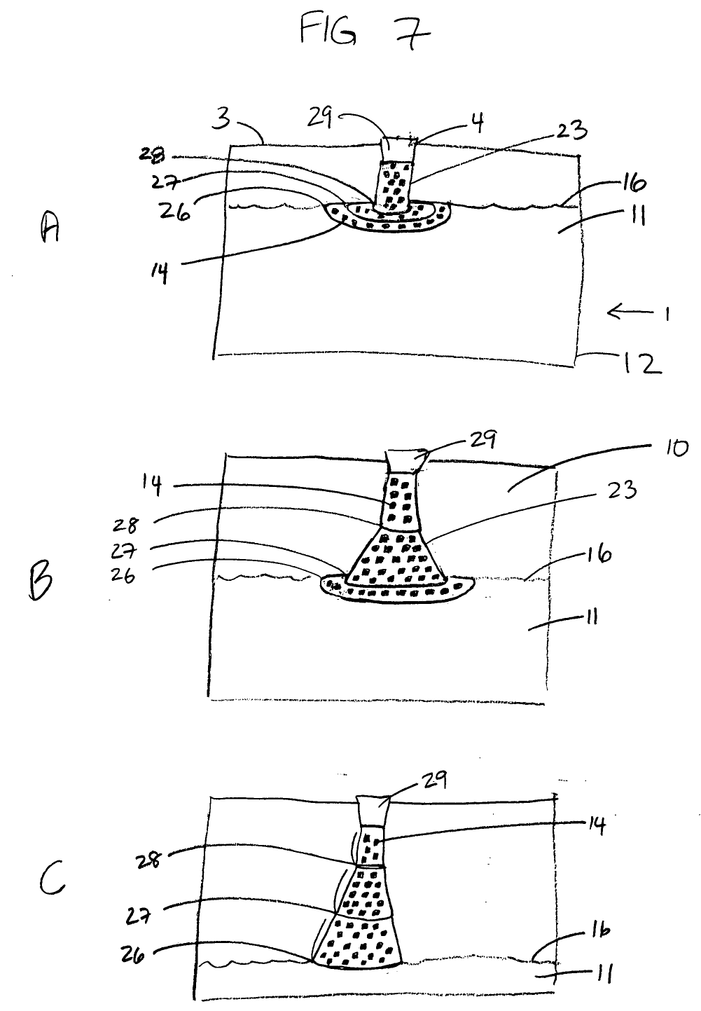

FIGS. 7A-C show a device of this invention with the water at high, medium, and low levels. The three tiers of the filter extend as the water level increases.

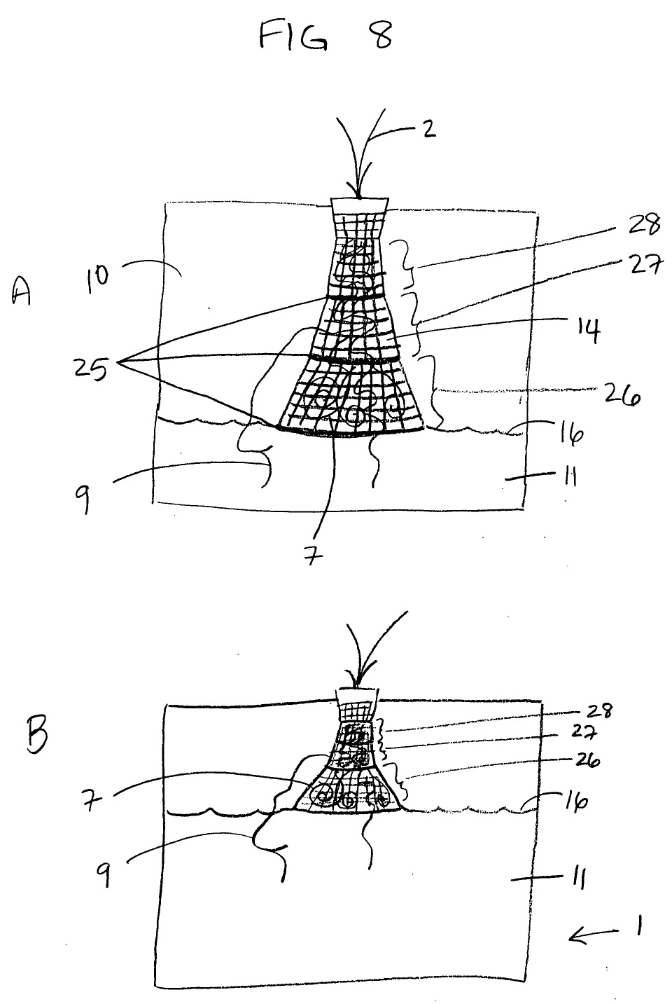

FIGS. 8A-B show a device of this invention with a mature plant and some roots growing in the interior of the filter and other roots growing in the filter and through the filter into the liquid. In FIG. 8A, the water level is low.

In an embodiment of this invention, the vessel 12 shown in FIG. 1 is partially filled with liquid 11 comprising water and nutrients such that the upper liquid surface 16 is below the rim 8. A filter 6 rests on the rim 8. A cover 3 for suspending a plant is placed on the vessel 12. A wick 5, which also serves as a plant support, is placed in the opening 4 in the cover 3 such that it passes through a wick hole 13 in the filter 6. Gas 10 comprising oxygen gas, typically air, is above the filter 6 below the cover and below the filter 6 above the liquid 11. A seed (not shown) is placed on the wick 5. The wick 5 has sufficient contact with the liquid 11 for water and nutrients to be absorbed by the wick 5 and delivered to the seed. The device 1 is placed in a gas comprising carbon dioxide gas, typically air. Photoradiation is provided from an artificial or natural source (not shown). After the passage of time, the seed germinates into a plant 2. Roots grow down through and out of the wick 5 into the vessel 12. As a root grows down, if it contacts the filter 6 at the matrix 21, it can grow along the filter 6 and/or back up into the gas 10 above the filter and grows as an air root 7. As a root grows down, if it contacts the filter 6 at a hole 14 that is sufficiently large, it can grow through the filter 6, into the gas 10 below the filter and into the liquid 11 and grows as a water root 9. Oxygen is delivered to the plant water roots 9 in the liquid 11 and to the air roots 7 in the gas 10. As liquid 11 evaporates and transpires, the liquid level falls. Before or about the time the liquid surface 16 falls below the bottom of the wick 5, more liquid 11 comprising water and nutrients is added to the vessel 12. The liquid level is maintained at or below the filter 6 and at or above the level of the bottom of the wick 5 until all selected portions of the plant 2 are harvested. The device 1 can be cleaned and reused, with a new filter 6, for growing another plant 2.

In an embodiment of this invention, the vessel 12 shown in FIG. 2 is partially filled with liquid 11 comprising water such that the upper liquid surface 16 is below the filter rests 17. Nutrients are added to the liquid 11 before or after the vessel 12 is filled. A filter 6 is placed on the filter rests 17. A cover 3 for suspending three plants is placed on the vessel 12. A wicking plant support 20 having a wick 5 attached is placed in each opening 4 in the cover 3 such that the wick 5 passes through one or more wick holes 13 in the filter 6. Gas 10 comprising oxygen gas, typically air, is above the filter 6 below the cover 3 and below the filter 6 above the liquid 11. A seed is placed on each of the plant supports 20 and optionally covered with a germination cover 24. Water and nutrients are absorbed by the wick 5, delivered to the plant support 20, absorbed by the plant support 20, and delivered to the seed. The device 1 is placed in a gas comprising carbon dioxide gas, typically air. Photoradiation is provided from an artificial 18 or natural 19 source. After the passage of time, the seed germinates into a plant 2. Roots grow down through and out of the plant support 20 into the gas 10 in the vessel 12. As a root grows down, if it contacts the filter 6 at the matrix 21, it grows along the filter 6 and/or back up into the gas 10 above the filter and grows as an air root 7. As a root grows down, if it contacts the filter 6 at a hole 14 that is sufficiently large, it grows through the filter 6, into the gas 10 below the filter and into the liquid 11 and grows as a water root 9. Oxygen is delivered to the plant water roots 9 in the liquid 11 and to the air roots 7 in the gas 10. As liquid 11 evaporates and transpires, the liquid level falls. Before or about the time the liquid surface 16 falls below the bottom of the wick 5, more liquid 11 comprising water and nutrients is added to the vessel 12. The liquid level is maintained at or below the filter 6 and at or above the level of the bottom of the wick 5 until all selected portions of the plant 2 are harvested. The device 1 can be cleaned and reused, with a new filter 6, for growing another plant 2.

In an embodiment of this invention, the vessel 12 shown in FIG. 3 is partially filled with liquid 11 comprising water. A cover 3 for suspending a plant and a filter 6 is placed on the vessel 12. A wicking hydrophilic filter 6 is hung from the cover 3 at the filter level 24, such that one or more portions of the filter 6 contact the liquid 11. The liquid upper surface 16 is maintained at about or below the filter level 24. A wick 5, which also serves as a plant support, is placed in an opening 4 in the cover 3 such that it rests on the filter 6. Gas 10 comprising oxygen gas, typically air, is above the filter 6 below the cover and optionally below the filter 6 above the liquid 11. A seed (not shown) is placed on the wick 5. Water and nutrients are absorbed by the filter 6, then the wick 5, and delivered to the seed. The device 1 is placed in a gas comprising carbon dioxide gas, typically air. Photoradiation is provided from an artificial or natural source (not shown). After the passage of time, the seed germinates into a plant 2. Roots grow down through and out of the wick 5 into the vessel 12. As a root grows down, if it contacts the filter 6 at the matrix 21, it grows along the filter 6 and/or back up into the gas 10 above the filter and grows as an air root 7. As a root grows down, if it contacts the filter 6 at a hole 14 that is sufficiently large, it grows through the filter 6, into the gas 10 below the filter and into the liquid 11 and grows as a water root 9. Oxygen is delivered to the plant water roots 9 in the liquid 11 and to the air roots 7 in the gas 10. As liquid 11 evaporates and transpires, the liquid level falls. Before or about the time the liquid surface 16 falls below the bottom of the filter 6, more liquid 11 comprising water and nutrients is added to the vessel 12. The liquid level is maintained at or below the filter level 24 and at or above the level of the bottom of the filter 6 until all selected portions of the plant 2 are harvested. The device 1 can be cleaned and reused, with a new filter 6, for growing another plant 2.

In an embodiment of this invention, the vessel 12 shown in FIG. 4 is partially filled with liquid 11 comprising water and nutrients. A wicking filter 6 is hung from the hooks 22 on a cover 3 which has openings 4 for two plants. The cover is placed on the vessel 12 such that the filter 6 floats at the liquid surface 16. A wicking plant support 20 is placed in each opening 4 in the cover 3 such that the filter 6 contacts the plant supports 20. Gas 10 comprising oxygen gas is in the vessel 12 above the liquid surface 16. A seed (not shown) is placed on each of the plant supports 20. Water and nutrients are absorbed by the filter 6, delivered to the plant support 20, absorbed by the plant support 20, and delivered to the seed. The device 1 is placed in a gas comprising carbon dioxide gas, typically air. Photoradiation is provided from an artificial or natural source (not shown). After the passage of time, the seed germinates into a plant 2. Roots grow down through and out of the plant support. As a root grows down it follows one of three options. First, it may grow vertically down through the column formed by the filter 6 (or partially horizontally into the filter 6 matrix 21 and back into the column) and into the liquid 11 where it grows as a water root 9. Alternatively it may grow horizontally out of the plant support 20 above the filter 6 or below the filter through a hole 14 in the filter 6 and into the gas. Second, if while growing through the gas, it contacts the filter 6 at the matrix 21, it grows along the filter 6 and/or back up into the gas 10 above the filter and grows as an air root 7. Third, while growing through the gas 10, it contacts the filter 6 at a hole 14 that is sufficiently large, it grows through the filter 6, into the liquid 11 and grows as a water root 9. Oxygen is delivered to the plant water roots 9 in the liquid 11 and to the air roots 7 in the gas 10. As liquid 11 evaporates and transpires, the liquid level falls, and the filter 6 falls with the liquid surface 16. The filter 6 is sufficiently buoyant and/or of sufficiently buoyant material to be able to float with air roots 7 weighing down on it. Before the liquid 11 is completely used by the plant 2, more liquid 11 comprising water and nutrients is added to the vessel 12. When liquid 11 is added, the filter floats on the surface 16 and keeps the air roots 7 above the surface 16 of the liquid 11. Liquid 11 is repeatedly added until all selected portions of the plant 2 are harvested. The device 1 can be cleaned and reused, with a new filter 6, for growing another plant 2.

FIGS. 6A and 6B show a wicking filter 23 and a filter cross-section of this invention. Only some of the one or more round holes 14 are shown in FIG. 6A. These filters have three tiers 26-28. The floatation means 25 is shown. The floatation means 25 can be a hollow plastic ring that it sewn into the filter.

FIGS. 7A-C show a wicking filter 23 with square holes 14 inside a device 1 of this invention. In FIG. 7A the water level is high in side the vessel 12 and the three tiers 26-28 of the filter are floating on the top of the liquid 11 at the liquid surface 16. The filter 23 is connected to the growing medium 29 in the hole 4 in the cover 3 of the device 1. In FIG. 7B the water is at a medium level. The first and second tiers 26-27 still float on the surface 16 of the liquid 11, but the third tier 28 is hanging in the air 10 inside the device 1. FIG. 7C shows a low water level. The first tier 26 of the filter 23 floats on the surface 16 of the liquid 11, but the second tier 27 and the third tier 28 hang in the gas from the grow plug 29.

FIGS. 8A and 8B show a wicking filter 23 with large rectangular holes 14 in a device 1 of this invention. As the plant 2 grows, roots grow into the filter 23 third tier 28, then optionally into the second tier 27, then optionally into the first tier 26, then optionally into the liquid 11. At any point, a root may exit the filter 23 through a hole 14 and continue growing in the gas 10 and into the liquid 11. Air roots 7 only growing in the gas 10 and a water root 9 that has grown into the liquid 16 are shown. When liquid is added to the device 1, the water level 16 rises and the floating means 25 causes the filter 23 to float on the surface. Because there are air roots 7 growing within the filter 23, the filter tiers do not completely collapse as they did in FIG. 7A. Because the first tier 26 floatation means 25 cross-sectional area is sufficiently larger than the second tier 27 which is sufficiently larger that the third tier 28, the tiers are not likely to tip over and suffocate the air roots 7 when the water level is raised.

The methods and devices of this invention are useful for quickly growing healthy productive plants. The devices of this invention include small, self-contained, portable devices for a home garden through large devices useful in the agricultural industry. The method and devices of this invention require no prior experience with growing plants, but also provide satisfying experiences and harvests for master gardeners. The methods and devices of this invention are useful for growing ornamental plants as well as plants for culinary and/or medicinal use. The devices of this invention are useful for growing plants at all stages, including from seed through harvests, growing plants from seed for transplant, growing plants from seedlings, and growing cuttings. Reproductive and vegetative tissues including flowers, shoots, leaves, and roots can all be produced and harvested using the methods and devices of this invention. When using the methods and devices of this invention, the volume of the vessel is selected for the type and number of plants to be grown.

This invention provides methods, devices, and kits for growing a plant or germinating a seed into a plant, said plant comprising a plurality of roots, said device comprising: a vessel for containing a liquid, said liquid comprising an uppermost surface; a suspending means for suspending said plant or seed in a gas above said liquid; a liquid delivering wicking filter supported by a filter supporting means, said filter having one or more holes; wherein at least a portion of said filter is at about or above the surface of said liquid; wherein said filter contacts said liquid and delivers said liquid to said seed or plant; wherein said filter decreases the likelihood that a first root of said plurality of roots grows through said filter and into said liquid or wherein said filter increases the mass of the portion of a second root that grows in said gas, each relative to an equivalent context without said filter.

In an embodiment, a first portion of said plurality of roots grows in said gas at about or above said filter and the remaining second portion of said plurality of roots grows through said one or more holes in said filter and into said liquid. In an embodiment, said device further comprises a second liquid delivery means for delivering a second liquid to said plant or seed above said filter and allowing said second liquid to descend through said filter to said first liquid.

In an embodiment, said filter contacts a wicking growing medium which contacts said seed or plant. In an embodiment, said filter supporting means is selected from the group consisting of: said plant or seed suspending means, floating means; said liquid surface for floating upon, and portions of said vessel. In an embodiment, said filter supporting means comprises at least a first floating means connected to said filter below a second floating means connected to said filter wherein said first floating floats a larger portion of filter than said second floating means. In an embodiment, said floating means comprises an about circular or about square shaped floating device.

In an embodiment, said filter comprises non-uniform holes. In an embodiment, each of said holes has a cross-sectional area, wherein each of said hole cross-sectional areas is less than 2.25 mm² or greater than 25 mm². In an embodiment, each hole has a shape and wherein said shape is a square or greater than an 80% rectangle. In an embodiment, said filter has a total cross-sectional area, wherein the sum of cross-sectional areas of all the holes in said filter is greater than 55% of the total cross-sectional area of said filter.

In an embodiment, said filter comprises a material selected from the group consisting of natural and synthetic materials, woven and nonwoven materials, textiles, fabric, coirs, burlaps, netting, capillary matting, polymers, foams, papyrus, linen, cotton, and silk. In an embodiment, said filter is capillary matting with holes. In an embodiment, none of said plurality of roots is allowed to grow through said filter and into said liquid below said filter. In an embodiment, all of said filter is moist. In an embodiment, said filter is stochastic or size selective.

This invention provides a method for growing a plant or germinating a plant from a seed comprising: providing a device of this invention wherein said liquid comprises water; delivering nutrients, carbon dioxide, oxygen, and photoradiation to said plant or seed; and allowing said plant to grow or said seed to germinate.

This invention provides a method for growing a plant or germinating a seed into a plant, said plant comprising a plurality of roots, said method comprising: providing a vessel for containing a liquid, said liquid comprising an uppermost surface; providing a suspending means and suspending said plant or said seed in a gas above said liquid; providing a liquid delivering wicking filter having one or more holes; wicking said liquid to said plant or seed with said filter; providing a supporting means and supporting at least a portion of said filter at about or above said liquid surface; and filtering at least a portion of said plurality of roots; whereby the likelihood that a first root of said plurality of roots grows through said filter and into said liquid is decreased or wherein the mass of the portion of a second root that grows in said gas is increased, each relative to an equivalent context without said filter and said filtering. In an embodiment, the method includes germinating said plant from seed.

This invention provides methods, devices, and kits that are useful for growing plants hydroponically or with soil. The devices of this invention include a vessel for containing a liquid and a gas comprising oxygen gas, a means for suspending a plant in the gas above the liquid, a means for delivering the liquid to the plant, and a filter. The methods of this invention provide the above-mentioned components and also deliver nutrients, carbon dioxide, and photoradiation, which can be delivered by any means known in the art.

In an embodiment of this invention, the walls of the vessel are not permeable to photoradiation and the suspending means removably covers the vessel. In an embodiment of this invention, the vessel and cover prevent unnecessary evaporation of water and entry of photoradiation and unwanted organisms. Some evaporation is desirable, as is known in the art, to assist in wicking the liquid up to the plant and to oxygenate the liquid as it is wicking. The suspending means is able to hold one or more plants. The plants are suspended by any means known in the art including by suspending a plant support such as a sponge in the opening by friction or a by hanging a basket that is filled with soil. Alternatively, the plants can be propped up by a portion of the vessel. In an embodiment of this invention, the vessel and cover are made of an opaque, light-colored plastic, that is not permeable to photoradiation and that absorbs little photoradiation. In an embodiment of this invention, the device is an enclosed chamber except for plant openings, which are large enough to allow for growth of the stem of each plant.

The additional means for delivering liquid can be any delivery means known in the art or yet to be invented in which roots are provided a gas space and a liquid space in which to grow, including, but not limited to wicking, flooding and draining, and nutrient film techniques. All wicking materials and methods known in the art or yet to be invented that provide an appropriate amount of liquid to a plant to allow it to grow are useful in the practice of this invention.

The filters of this invention decrease the likelihood that a root of a plant will grow into the liquid 11 in the vessel 12. The filter is optionally designed to allow some of the roots to grow into the liquid, e.g., water roots, while directing some roots to grow in the air, e.g., air roots, above the filter. The filter functions as a statistical, stochastic or random filter. The presence of the filter decreases the likelihood that any individual root will grow into the liquid compared to an equivalent context with the absence of the filter. The devices of this invention promote the growth of more air roots than would form or grow in a device without a filter.

In the methods and devices of this invention, at least a portion of the filter is above or at about the surface of the liquid. The filter can be suspended, held up, or left to float at about or above the surface of the liquid. Preferably the filter can be lifted out of the vessel with the plants.

A filter has one or more holes and a matrix between the holes. One of the holes can allow a wick or other liquid delivery means to pass. As a root of a plant grows towards the filter, if it contacts the filter at a hole (e.g., fluidly contacts, no solid contact with matrix), it can pass through the filter and into the liquid. If it contacts the filter at the matrix, it is prevented from passing directly through the filter. The filter may prevent some roots from ever entering the liquid or promote more root growth before a root enters the liquid. The presence of the filter promotes the growth of more air roots.

Preferably filter materials, hole/matrix percentage, and the shape and cross-sectional area of the holes are selected to optimize delivery of nutrients, oxygen, and water to the plant. Water and nutrients are obtained by the plant by the water roots growing in the liquid or by roots in contact with a wick or another material that has absorbed the liquid, such as a hydrophilic filter. Oxygen is obtained by the air roots growing in the oxygen-containing gas or by water roots growing in the dissolved-oxygen-containing liquid. The liquid contains dissolved oxygen from diffusion, evaporative wicking, or any other oxygen dissolving means utilized. Many methods for dissolving oxygen in water are known in the art.

The devices and methods of this invention utilize filters that have one or more holes, each having a cross-sectional area and a shape. The shape and cross-sectional area of at least one hole should be sufficient for at least one root of the selected plant to pass through. In an embodiment of this invention, when the holes are all of a square or greater than 80% rectangle shape, the cross-sectional areas are less than about 2 mm², less than 2.25 mm², or greater than about 10 mm², 15 mm², 25 mm² or 30 mm². The filters optionally have one or more holes for the delivery means to pass through. In embodiments of this invention, the filter is less than about 50% or about 55% hole and more than about 45% or about 50% matrix (matrix ratios of about 50-55:45-50 hole:matrix). Filters useful in the practice of this invention include filters having a hole:matrix ratio that varies with time as more air roots grow. An example of such a filter is shown in FIG. 5. The filter is made of capillary wicking material strips that are flexible and bend, changing the cross-sectional area and shape of the holes as the roots grow and contact the filter.

Filters useful in the practice of this invention can be made from one or more materials including, but not limited to, natural and synthetic materials, woven and nonwoven materials, plastics, woods, metals, textiles, fabric, coir, burlap, netting, capillary matting, rubber, polymers, foams, glass, papyrus, linen, cotton, and silk. Examples of useful filter materials include polyethylene hardware cloth (Catalog No. 9314T29, McMaster-Carr, Chicago Ill., USA), stainless steel mesh (Catalog No. 9344T18, McMaster-Carr, Chicago Ill., USA), perforated metal sheet (Catalog No. 9232T23, McMaster-Carr, Chicago Ill., USA), burlap (Catalog No. 8814K22, McMaster-Carr, Chicago Ill., USA), and capillary wicks (CapMatII, Phytotronics, Inc., Earth City, Mo., USA and No. 1284, Boulder Hydroponic & Organic Center Inc., 1630 63rd #5, BOULDER, Colo., USA). Holes can be created in materials as is known in the art.

In the devices of this invention, filters can be oriented horizontally or diagonally. In an embodiment of this invention, a set of layered filters is utilized. In an embodiment of this invention, each filter of a set has a different arrangement, cross-sectional area, shape, or percentage of holes/matrix.

The devices and methods of this invention are useful for growing one, two, or more than two plants. When two or more plants are grown, separate filters for separating the air roots of each plant are optionally utilized.

When using a device of this invention, when air roots are present, the liquid level should not be above the lowest level of the air roots. The maximum fill line for a device of this invention is low enough that the air roots are not submerged with liquid and high enough that the liquid delivery system can deliver liquid to the plant. Preferably the maximum fill line is also high enough or the vessel large enough that the liquid does not need to be replenished inconveniently often. During the slow phase of plant growth, liquid may only need to be replenished every couple of weeks, but during periods of high growth, liquid may need to be replenished daily. When replenishing liquid, care must be taken to not add liquid above the level of the air roots, therefore care must be taken to avoid adding liquid above the level of the filter. Optionally a device of this invention comprises a means for preventing adding liquid above the level of the filter, e.g., a liquid outlet at the filter level or a liquid level gauge having a guide for the recommended maximum liquid level. Overfilling can cause the roots to be suffocated and the plant to be deprived of oxygen, resulting in plant illness, death, or reduced harvest.

When checking the liquid level in a device of this invention or when replenishing liquid, it is preferable to not damage any roots. Roots can be damaged, for example, by pulling water roots up through the filter. A device of this invention can include a means for checking the liquid level or for replenishing liquid without damaging roots, e.g., a window into the vessel and a door in the cover 3 or a vessel 12 side wall. In an embodiment, the filter or a wick extending below the filter extends to the bottom of the vessel, so that at any liquid level, the filter wicks liquid. In an embodiment, there is a maximum liquid level that is low enough from the cover of the device that the air roots which are floated upwards by the floating wicking filter are never suffocated.

Germination covers 24 are covers that prevent substantial evaporation of liquid 11 from the device. They are useful for temporarily covering portions of a liquid delivery means, such as a wick, to prevent evaporation through an opening 4 in a cover 3. Germination covers 24 are not permeable to liquid but optionally permeable to photoradiation. Germination covers 24 are also useful to prevent evaporation from an opening 4 that does not have plant 2 in it.

The methods and devices of this invention are useful for all plant growth stages from germination through multiple harvests. After use, the vessel and cover can be cleaned, optionally in a dishwasher, before reuse. The filter can be discarded and replaced or cleaned and reused. Wicking filters typically are transplanted into the ground with a plant grown using the device or discarded.

The devices and kits of this invention optionally also comprise a liquid inlet, a liquid outlet, one or more germination covers, a greenhouse lid, a decorative outer vessel container, seeds, different filters for different types of plants or for harvesting different plant tissues, replacement filters, a pump, tubing, nutrients, means for detecting, providing, and/or modifying nutrients, photoradiation quantity and/or quality, temperature, fluid level, dissolved oxygen, pH of the liquid, means for detecting and quantitating unwanted organisms (e.g., anaerobic bacteria and algae), means for reporting results of various assays. Optionally, a device of this invention comprises a means for preventing overfilling the liquid. The means for assaying and/or modifying can include use of machine readable storage devices, program storage devices, and data sets regarding which plants are being grown and optimal nutrient concentration, temperatures, pH levels etc.

In an embodiment of this invention, seeds are germinated on a removable plant support in a germination device, which can be a device of this invention, and after germination, the plant support and germinated seeds can be removed and placed in a second device, such as a device of this invention, for further growth. Optionally the second device comprises a vessel of a different size.

In an embodiment, the filter is less than 5mm above the liquid uppermost surface. In an embodiment, the first portion comprises air roots and said remaining second portion comprises water roots. In an embodiment, the device is for growing two or more plants. In an embodiment, the device comprises a separable filter for each of said two or more plants. In an embodiment, the filter also delivers a nutrient in said liquid to said seed or plant. In an embodiment, the device comprises a second delivery means such as a second wicking means or any other hydroponic means. In an embodiment, the method further comprises delivering a second liquid to said plant or seed above said filter and allowing said second liquid to descend along said filter. In an embodiment, the filtering is stochastic and by chance or the filtering is selective based on root cross-sectional diameter and shape.

This invention provides a method for delivering oxygen to a plant comprising: providing a vessel for containing a liquid; providing a suspending means and suspending said plant in a gas comprising oxygen above said liquid; providing a liquid delivering hydrophilic wicking filter; delivering said liquid to said plant or seed with said filter; and filtering a plurality of roots of said plant whereby the likelihood that a first root of said plurality of roots grows through said filter and into said liquid is decreased or wherein the mass of the portion of a second root that grows in said gas is increased, each relative to an equivalent context without said filter and said filtering; whereby said oxygen in said gas is delivered to said plurality of roots in growing in said gas.

This invention provides a plant root filtering device comprising: a first wicking filter portion having one or more holes; a first floating means connected to said first filter portion; a second wicking filter portion having one or more holes, said second wicking filter portion contacting and suspending said first wicking portion; a second floating means connected to said second filter portion; a means for contacting said second filter portion to a plant having a root, a seed which will germinate into a plant, or a plant growing medium; wherein said filtering device is capable of delivering a liquid to said seed, plant, or growing medium; wherein a root is allowed to grow through a hole in said device; and wherein when said device is suspended in a gas above a liquid, the likelihood that a first root of said plurality of roots grows through said filter and into said liquid is decreased or wherein the mass of the portion of a second root that grows in said gas is increased, each relative to an equivalent context without said filter and said filtering. In an embodiment, the filter also comprises a means for contacting the filter to a growing medium or a basket for holding a growing medium.

In an embodiment, liquid never needs to be delivered to the plant or seed by any means other than the wicking filter, from germination through harvest.

The devices and methods of this invention are improvements over other hydroponics devices and methods using nets or screens because the filters of this invention not only filter roots but also deliver water to the plant and seed, and remain wet throughout growth, encouraging roots to grow along the filter surface and not grow along another wicking means or towards the liquid below. The filters of this invention that include a floating means also prevent roots from being suffocated when water is added. The filters of this invention and the devices of this invention containing these filters promote more air root growth than non-wicking nets or screens and devices containing them.

### EXAMPLE 1

Two plants 2 are grown from seed using a device similar to the device illustrated in FIG. 1. An 18×6×5 inch (l×w×h) vessel 12 has a cover 3 having two openings 4 for two plants. Two growing media compositions connected to two tiered wicking filters 6 made of capillary matting material (CapMatII, Phytotronics, Inc., Earth City, Mo., USA) are inserted in the two openings 4. The vessel is filled with water 11. The capillary matting material has had regularly spaced 6mm square holes 14 cut into it so that it is 40% hole 14 and 60% matrix 21. The vessel is filled with water to a level below the growing media compositions. Nutrients are added. Air (normal earth atmosphere) is allowed into and to surround the vessel. The wicking filters 6 contact the liquid 11 and are suspended in the air and in the water 11 to a level just above the bottom wall of the vessel 12. An artificial photoradiation source 18 is placed several inches from the cover. Three tomato seeds are planted on one growing medium and three lettuce seeds are planted on the other. The photoradiation source provides photoradiation for 16 of every 24 hours. The filters wick water up to the growing media. After several days, each seed has germinated. During week 1, the water level is checked, and it is determined that no water needs to be added. During week 2 the water level is checked and more water 11 with nutrients is added up to the maximum fill line. By week 2 the tomato and lettuce roots have grown out of the growing media and into the air space within the filters. By the end of week 3, some of the roots have growing through the holes in the filters and into the water. At week 3, outer lettuce leaves are harvested. Water is added to maintain the water level at least as high as the bottom of the filter. Nutrients are added every other week. Lettuce leaves are harvested several times weekly. Beginning at week 4, water and nutrients are added about 3 times weekly. Beginning at week 6, water and nutrients are added daily. At week 8, the lettuce plant 2 is removed along with some of its roots and the wicking filter. At week 12, a tomato is harvested. Tomatoes are harvested for each week thereafter.

Although this invention has been described with respect to specific embodiments, it is not intended to be limited thereto, and various modifications which will become apparent to the person of ordinary skill in the art are intended to fall within the scope of the invention as described herein, taken in conjunction with the accompanying drawings and the appended claims.

1. A device for growing a plant or germinating a seed into a plant, said plant comprising a plurality of roots, said device comprising:
a) a vessel for containing a liquid, said liquid comprising an uppermost surface;
b) a suspending means for suspending said plant or seed in a gas above said liquid;
c) a liquid delivering wicking filter supported by a filter supporting means, said filter having one or more holes; wherein at least a portion of said filter is at about or above the surface of said liquid;
wherein said filter contacts said liquid and delivers said liquid to said seed or plant;
wherein said filter decreases the likelihood that a first root of said plurality of roots grows through said filter and into said liquid or wherein said filter increases the mass of the portion of a second root that grows in said gas, each relative to an equivalent context without said filter.

2. The device of claim 1 wherein a first portion of said plurality of roots grows in said gas at about or above said filter and the remaining second portion of said plurality of roots grows through said one or more holes in said filter and into said liquid.

3. The device of claim 1 wherein said device further comprises a second liquid delivery means for delivering a second liquid to said plant or seed above said filter and allowing said second liquid to descend through said filter to said first liquid.

4. The device of claim 1 wherein said filter contacts a wicking growing medium which contacts said seed or plant.

5. The device of claim 1 wherein said filter supporting means is selected from the group consisting of: said plant or seed suspending means, floating means; said liquid surface for floating upon, and portions of said vessel

6. The device of claim 5 wherein said filter supporting means comprises at least a first floating means connected to said filter below a second floating means connected to said filter wherein said first floating floats a larger portion of filter than said second floating means.

7. The device of claim 5 wherein said floating means comprises an about circular or about square shaped floating device.

8. The device of claim 1 wherein said filter comprises non-uniform holes.

9. The device of claim 1 wherein each of said holes has a cross-sectional area, wherein each of said hole cross-sectional areas is less than 2.25 mm² or greater than 25 mm².

10. The device of claim 1 wherein each hole has a shape and wherein said shape is a square or greater than an 80% rectangle.

11. The device of claim 1 wherein said filter has a total cross-sectional area, wherein the sum of cross-sectional areas of all the holes in said filter is greater than 55% of the total cross-sectional area of said filter.

12. The device of claim 1 wherein said filter comprises a material selected from the group consisting of natural and synthetic materials, woven and nonwoven materials, textiles, fabric, coirs, burlaps, netting, capillary matting, polymers, foams, papyrus, linen, cotton, and silk.

13. The device of claim 1 wherein said filter is capillary matting with holes.

14. The device of claim 1 wherein none of said plurality of roots is allowed to grow through said filter and into said liquid below said filter.

15. The device of claim 1 wherein all of said filter is moist.

16. The device of claim 1 wherein said filter is stochastic or size selective.

17. A kit for growing a plant comprising the device of claim 1 and instructions for using said device.

18. A method for growing a plant or germinating a plant from a seed comprising:
a) providing a device of claim 1 wherein said liquid comprises water;
b) delivering nutrients, carbon dioxide, oxygen, and photoradiation to said plant or seed; and
c) allowing said plant to grow or said seed to germinate.

19. A method for growing a plant or germinating a seed into a plant, said plant comprising a plurality of roots, said method comprising:
a) providing a vessel for containing a liquid, said liquid comprising an uppermost surface;
b) providing a suspending means and suspending said plant or said seed in a gas above said liquid;
c) providing a liquid delivering wicking filter having one or more holes;
d) wicking said liquid to said plant or seed with said filter;
e) providing a supporting means and supporting at least a portion of said filter at about or above said liquid surface; and
f) filtering at least a portion of said plurality of roots;
whereby the likelihood that a first root of said plurality of roots grows through said filter and into said liquid is decreased or wherein the mass of the portion of a second root that grows in said gas is increased, each relative to an equivalent context without said filter and said filtering.

20. The method of claim 19 comprising germinating said plant from seed.
